(19) United States
(12) Patent Application Publication
(10) Pub. No.: US 2004/0156152 A1
(43) Pub. Date: Aug. 12, 2004

(54) Device for Error Detection and Locking of Power Breakers

(75) Inventor: Tomas Kalender, Pforzheim (DE)

Correspondence Address: GUDRUN E. HUCKETT DRAUDT, LONSSTR. 53, WUPPERTAL, 42289, DE

(73) Assignee: STOBER ANTRIEBSTECHNIK GMBH + CO., Pforzheim (DE)

(21) Appl. No.: 10/707,266

(22) Filed: Dec. 2, 2003

(30) Foreign Application Priority Data
Dec. 6, 2002 (DE) 202 19 467.1

(51) Int. Cl. H02H 5/04

(52) U.S. Cl. 361/23

(57) ABSTRACT

A device for error detection and mutual locking of at least two switches that sequentially connect motors to a converter has a converter sending switching signals to the at least two switches. The converter, prior to each switching action, checks a switched-off state of all of the at least two switches. The converter performs a current measurement for checking the switched-off state.

### BACKGROUND OF INVENTION

1. Field of the Invention

The invention relates to a device for error detection and mutual locking of at least two power breakers that sequentially connect motors to a converter.

2. Description of the Related Art

In practice (FIG. 2), several motors 4 are often alternatingly operated on a single power amplifier 1 to which the motors 4 are connected by means of motor leads 2. Switching of the motor leads 2 is realized, for example, by a relay or contactors 3. When controlling these switches, for example, the coil 5 of a contactor 3, it must be prevented that due to an error two motors 4 start up simultaneously. Such an error can be caused, for example, by sticking of the contactors of a motor. The conventional solution resides in a locking device within the control circuit of the contactors 3. Each contactor 3 is provided with additional break contacts 7 that, when the contactor 3 is switched on, interrupts the current supply to the other contactor coils. As a result of the additional contacts and of the external wiring, this known device is constructively very complex.

### SUMMARY OF INVENTION

It is an object of the present invention to configure the device of the aforementioned kind such that an error detection is ensured without requiring any additional wiring expenditure.

In accordance with the present invention, this is achieved in that the converter sends the switching signals to the contactors and in that the converter, prior to each switching process, checks the switched-off state of all contactors.

The device according to the invention does not require any additional auxiliary contacts and external wiring. Alone by means of the sensory device provided within the convertor, the convertor diagnoses the occurring errors of the switches. In this way, simultaneous start-up of two or more motors is prevented without constructive expenditure.

### BRIEF DESCRIPTION OF DRAWINGS

FIG. 1 is a circuit diagram of the device according to the invention.

FIG. 2 is a circuit diagram of a device according to the prior art.

### DETAILED DESCRIPTION

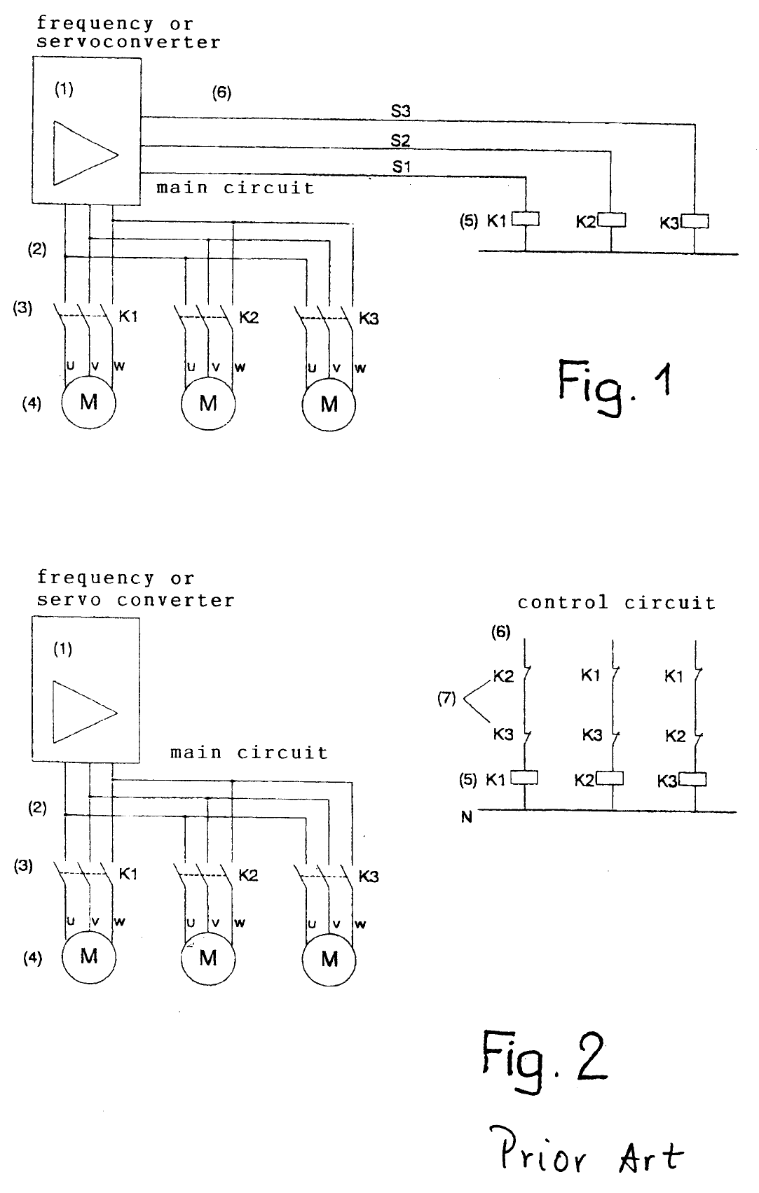

The device according to FIG. 1 has a converter that can be a frequency converter or a servo converter. By means of the converter, three motors 4 are alternatingly switched in the illustrated embodiment. Depending on the application, only two motors or more than three motors can be switched also by a single converter 1.

The motors 4 are connected by means of motor leads 2 to the converter 1 via switches 3 that can be contactors, relays or other power breakers. The switches 3 each have a switching element 5; in the illustrated embodiment, the switching element is a coil. Each switching element 5 is connected by means of a signal lead 6 to the converter 1. In deviation from the illustrated embodiment, the signal leads 6 can also be connected to an external switching device that, in turn, is connected to the converter 1 and receives from the converter 1 the corresponding signals to be supplied to the switching elements 5.

In the illustrated embodiment, all three switches 3 are open. When a switch 3 of one of the motors 4 is to be closed, the corresponding switching signal is sent by the converter 1 via the corresponding signal lead 6.

Prior to this, the converter 1 checks whether all three switches 3 are open. This check is carried out by means of a sensory device provided within the converter 1. For this purpose, the converter 1 tries, for example, to impress a certain electric current onto the motor leads 2. When this is successful, a reliable indicator is present that at least one of the switches 3 is closed. The converter 1 then switches off its output stage and signals a disturbance. In this way it is reliably prevented that as a result of a switching error at the same time two or more motors can start up (“locking”). In general, the converter 1 will send a disturbance signal when one of the switches 3 is in a different switching state than that preset by the switching signals.

In order to prevent a destruction of the motors 4 by the check that is performed, the current level is matched to the specifications of the motor 4 to be checked.

The check by means of the sensory device of the converter 1 is carried out prior to each switching step. In this way, the converter 1 reliably detects possible errors of the switches 3.

While specific embodiments of the invention have been shown and described in detail to illustrate the inventive principles, it will be understood that the invention may be embodied otherwise without departing from such principles.

What is claimed is:

1. A device for error detection and mutual locking of at least two switches that sequentially connect motors to a converter, the device comprising:
a converter sending switching signals to the at least two switches, wherein the converter, prior to each switching action, checks a switched-off state of all of the at least two switches.

2. The device according to claim 1, wherein the converter performs a current measurement for checking the switched-off state.

3. The device according to claim 1, wherein the converter sends an error message when one of the at least two switches is in a switching state that is different from a switching state preset by the switching signals.

4. The device according to claim 1, comprising signal leads connected to the converter.

5. The device according to claim 4, wherein the signal leads are connected via an external switching device to the converter, wherein the external switching device receives the switching signals from the converter.
